(19) United States
(12) Patent Application Publication
(10) Pub. No.: US 2005/0082986 A1
(43) Pub. Date: Apr. 21, 2005

(54) Light-emitting lamp, and illumination apparatus and projector provided with the light-emitting lamp

(75) Inventors: Takeshi Takezawa, Matsumoto-shi (JP); Toshiaki Hashizume, Okaya-shi (JP)

Correspondence Address: OLIFF & BERRIDGE, PLC, P.O. BOX 19928, ALEXANDRIA, VA, 22320, US

(73) Assignee: SEIKO EPSON CORPORATION, Toyko (JP)

(21) Appl. No.: 10/921,105

(22) Filed: Aug. 19, 2004

(30) Foreign Application Priority Data
Aug. 27, 2003 (JP) 2003-302476

(51) Int. Cl. H01J 17/16

(52) U.S. Cl. 313/634

(57) ABSTRACT

In order to provide a light emitting lamp that makes it possible to control the light emitting lamp to be at a target temperature, for a light emitting lamp including a valve portion 2 and sealing portions 3a and 3b, a quantity of power-consumption-dependent heat losses due to convection and conduction of the valve portion 2, the inside diameter of the valve portion 2, and the diameter and the length of the sealing portions 3a and 3b are determined in advance, and the outside diameter of the valve portion 2 is determined on the basis of these quantity of heat losses, inside diameter of valve portion, diameter, of sealing portions, and length of sealing portions, so that an average value of inner temperatures of the light valve portion 2 at the time of luminescence falls within a range from 900 to 1000° C.

### TECHNICAL FIELD

The present invention relates to a light emitting lamp, a lighting apparatus equipped with a light emitting lamp, and a projector equipped with a light emitting lamp.

### BACKGROUND ART

It is crucial to control a temperature for a light emitting lamp, in particular, a light emitting lamp for which high luminance is required to be used in a projector. Moreover, as is described, for example, in JP-UM-A-5-87806 (page 7, FIG. 1), a reflection film is deposited on a valve portion (or a light emitting portion) in a light emitting lamp, or as is described, for example, in JP-A-8-31382 (page 2, FIG. 1), a second reflection mirror (or a secondary mirror) is provided to the light emitting lamp, for light to be utilized efficiently. In these cases, because heat generation in the valve portion is increased compared with a case when the reflection film or the like is absent, the temperature control is more crucial.

### DISCLOSURE OF THE INVENTION

Heat generated in the valve portion of the light emitting lamp is released from the valve portion into air and to the sealing portions on the both sides of the valve, and the sizes of the valve portion and the sealing portions therefore become an important factor for the temperature control of the light emitting lamp. The invention was devised in view of the foregoing, and has an object to provide a light emitting lamp whose sizes are determined so that a temperature associated with light emission of the light emitting lamp can be controlled to be at a target temperature, and a lighting apparatus or a projector equipped with such a light emitting lamp.

A light emitting lamp of the invention is a light emitting lamp including a valve portion enclosing a pair of electrodes, and sealing portions placed integrally with the valve portion on both sides of the valve portion and provided with conductors connected to the electrodes, which is characterized in that: three values among values of four sizes, including an inside diameter of the valve portion, an outside diameter of the valve portion, a diameter of the sealing portions, and a length of the sealing portions, and a value of a quantity of power-consumption-dependent heat losses due to convection and conduction of the valve portion are determined in advance, and a value of a remaining one size among respective sizes of the valve, portion is determined on the basis of the determined values, for an average value of inner temperatures of the valve portion to be a target, value determined in advance. It is thus possible to achieve stable light irradiation by preventing an excessive increase or an excessive drop of the inner temperature of the light emitting lamp.

Also, for the light emitting lamp of the invention, it is preferable that: the quantity of heat losses due to convection and conduction of the valve portion, the inside diameter of the valve portion, the diameter of the sealing portions, and the length of the sealing portions are determined in advance; and the outside diameter of the valve portion is determined on the basis of the quantity of heat losses, the inside diameter of the valve portion, the diameter of the sealing portions, and the length of the sealing portions, for the average value of the inner temperatures of the valve portion to fall within a target range. It is thus possible to determine the outside diameter of the valve portion according to the quantity of heat losses due to convection and conduction of the valve portion.

Also, for the light emitting lamp of the invention, it is preferable that let TT be a surface temperature of the valve portion, H be the quantity of heat losses due to convection and conduction of the valve portion, TH be a thickness of the valve portion, p be a coefficient of heat conduction of a material forming the valve and the sealing portions, MS be a valve area at a center position in a thickness direction of the valve portion, and ITT be the average value of the inner temperatures, then ITT is given as:
ITT=TT+(H·TH)/(ρ·MS)

Also, for the light emitting lamp of the invention, it is preferable that: let T be a surface temperature of the valve portion on the assumption that no heat is released from the sealing portions of the valve portion, R3 be a combined resistance of a heat resistance R1 from the valve portion to natural convection and a heat resistance R2 from the valve portion to the sealing portions through conduction, l be the length of the sealing portions, and d be the diameter of the sealing portions, then we get:
TT=H·R3,
R3=(R1·R2)/(2R1+R2),
R1=T/H,
R2=1/(ρ·π·(d/2)<SUP>2</SUP>)

Also, for the light emitting lamp of the invention, it is preferable that the average value of the inner temperatures is set to 900° C. or above and 1000° C. or below. When configured in this manner, it is possible to prevent the glass surface forming the light emitting lamp from turning opaque or black.

Further, for the light emitting lamp of the invention, it is preferable that an angle, produced by a virtual line linking a center between the electrodes of the valve portion and one end of a boundary of the valve portion and the sealing portions and a reference line linking the electrodes, is set to be within 40 degrees. It is thus possible to keep a ratio of luminescent light generated in the electrodes and blocked by the sealing portions when it is emitted from the valve portion to 20% or less.

Moreover, it is preferable that the light emitting lamp of the invention further includes reflection means for returning light emitted from the valve portion again to the valve portion. In the case of this light emitting lamp, the inside temperature of the valve portion can be controlled to be at the target temperature while light is utilized efficiently.

A lighting apparatus of the invention is a lighting apparatus in which a lamp is fixed to a bottom of a concave reflection mirror, which is characterized in that any of the light emitting lamps described above is provided as the lamp. It is thus possible to provide a lighting apparatus equipped with a lamp that emits light at stable illuminance, because an average value of the inner temperatures of the valve portion is automatically controlled to be at the target temperature while the lamp is emitting light.

A projector of the invention is a projector to form an image by allowing illumination light from a lighting apparatus to go incident on a light modulation device for the image to be projected, which is characterized in that the lighting apparatus according to claim 8 is provided as a light source of the lighting apparatus. It is thus possible to provide a projector achieving the same advantages as the advantages of the lighting apparatus described above.

### BRIEF DESCRIPTION OF THE DRAWINGS

[FIG. 1]

FIG. 1 is an outside view of a mercury lamp according to a first embodiment of the invention.

[FIG. 2]

FIG. 2 is an outside view showing dimensional notations of the mercury lamp of FIG. 1.

[FIG. 3]

FIG. 3 is a schematic view showing heat resistances of the mercury lamp of FIG. 1.

[FIG. 4]

FIG. 4 is an outside view used to explain the boundary of a valve portion and sealing portions of the mercury lamp of FIG. 1.

[FIG. 5]

FIG. 5 is an explanatory view for a light distribution characteristic by a light source having a specific reference length and homogeneous brightness.

[FIG. 6]

FIG. 6 is a graph showing an example of analysis on the outside diameter of the valve portion of the light emitting lamp without a second reflection mirror.

[FIG. 7]

FIG. 7 is a graph showing an example of analysis on the outside diameter of the valve portion of the light emitting lamp with the second reflection mirror.

[FIG. 8]

FIG. 8 is a view showing a first configuration of a lighting apparatus according to a second embodiment of the invention.

[FIG. 9]

FIG. 9 is a view showing a second configuration of a lighting apparatus according to the second embodiment of the invention.

[FIG. 10]

FIG. 10 is a view showing the configuration of an optical system of a projector according to a third embodiment of the invention.

[FIG. 11]

FIG. 11 is an outside view of a mercury lamp whose valve portion has a spherical outside shape and a spheroidal inside shape.

[FIG. 12]

FIG. 12 is an outside view of a mercury lamp whose valve portion has spheroidal outside and inside shapes.

### BEST MODE FOR CARRYING OUT THE INVENTION

Embodiments of the invention will now be described with reference to the drawings.

First Embodiment

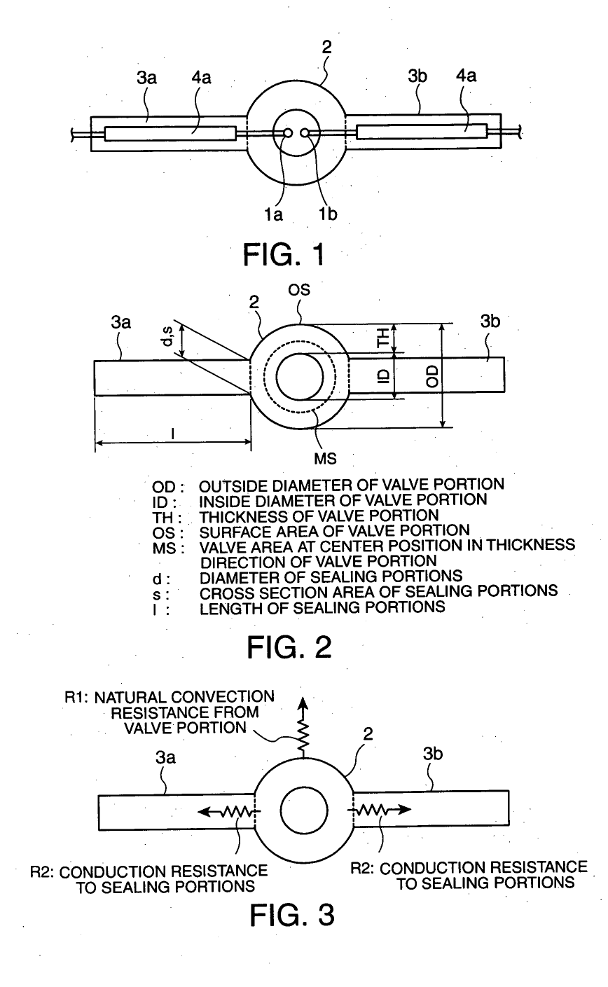

Hereinafter, a light emitting lamp of the invention will be described using a mercury lamp by way of example. FIG. 1 is an outside view of a mercury, lamp used to describe a first embodiment of the invention. The mercury lamp of FIG. 1 includes a valve portion 2 of nearly a spherical shape (including a shape of nearly a sphere), enclosing a pair of discharge electrodes 1a and 1b. Also, sealing portions 3a and 3b, extending continuously from the valve portion 2 on the right side and the left side to have the same diameter and length, are provided integrally with the valve portion 2 on the both sides of the valve portion 2.

The valve portion 2 and the sealing portions 3a and 3b are formed integrally from a transparent material, such as vitreous silica. Inside the sealing portions 3a and 3b are provided conductors 4a and 4b, respectively, that are connected to the electrodes 1a and 1b, respectively, and these conductors extend to the outside from the end portions of the sealing portions 3a and 3b. Mercury, an inert gas and the like sealed within the valve portion 2 are omitted from FIG. 1.

The mercury lamp as shown in FIG. 1 is known to have energy distribution set forth in Table 1 below from actual measurements. Of these measurements, the invention considers heat losses due to convection and conduction. This is because these heat losses chiefly contribute to heat generation of the valve portion 2. Table 1 below reveals that heat loss energy due to convection and conduction accounts for 6.6% of the total. Heat losses indicated according to predetermined lamp power consumption (referred to also as rated power, hereinafter, referred to as lamp power) are set forth in Table 2 below. Table 2 below reveals that a heat loss due to convection and conduction is 6.6 W when the lamp power is 100 W, a heat loss due to convection and conduction is 8.6 W when the lamp power is 130 W, and a heat loss due to convection and conduction is 9.9 W when the lamp power is 150 W.

TABLE 1

| | | Energy Distribution without |
|---|---|---|
| | | Second Reflection Mirror |
| UV rays | | 10.0% |
| Visible | 380-430 nm | 5.1% |
| | 430-670 nm | 21.3% |
| | 670-780 nm | 3.6% |
| Infrared rays | | 30.0% |
| Heat Loss | Radiation | 23.4% |
| | Convection · Conduction | 6.6% |

TABLE 2

| | Heat Loss (W) Due to Convection · Conduction |
|---|---|
| Lamp Power (w) | without Second Reflection Mirror |
| 100 | 6.6 |
| 130 | 8.6 |
| 150 | 9.9 |
| 165 | 10.9 |
| 180 | 11.9 |
| 200 | 13.2 |
| 250 | 16.5 |
| 300 | 19.8 |

In the light emitting lamp, when respective sizes (inside diameter ID of valve portion, outside diameter OD of valve portion, diameter d of sealing portions, and length l of sealing portions) of the valve portion 2, and a quantity of heat losses due to convection and conduction are known, it is possible to calculate the surface temperature and the inner temperature logical value of the valve portion 2 at the time of luminescence. Hence, three values among the values of four sizes, including the inside diameter ID of valve portion, the outside diameter OD of valve portion, the diameter d of sealing portions, and the length l of sealing portions, and lamp-power-dependent heat losses (or a quantity of heat losses) H due to convection and convection of the valve portion 2 are determined in advance, then, a value of the size that has not been determined among the respective sizes of the valve portion 2 can be determined on the basis of these determined values for the inner surface logical value of the valve portion 2 to take a predetermined target value. For example, when the inner diameter ID of the valve portion 2, the diameter d of the sealing portions 3a and 3b, the length l of the sealing portions 3a and 3b, and the target value of the inner temperature logical value of the valve portion 2 are preset, it is possible to determine the outside diameter OD of the valve portion 2 on the basis these values.

An example of the procedure to eventually find the outside diameter OD of the valve portion 2 will be described in detail with reference to FIG. 2 and FIG. 3. Notations used below are defined as follows:
OS: outside surface area of valve portion
C: shape factor of heat transmission due to natural convection of a sphere=0.63
OD: outside diameter of valve portion.
d: diameter (diameter) of sealing portions
s: cross section area of sealing portions
l: length of sealing portions
ID: inside diameter of valve portion
TH: thickness of valve portion
MS: valve area at the center position in the thickness direction of valve portion
R1: natural convection resistance from valve portion
R2: conduction resistance to sealing portions.

The outside surface area OS of the valve portion 2 of FIG. 2 (an area excluding contact portions to the sealing portions 3a and 3b) is expressed by:

$$OS = 4 {π ( OD / 2 )}^{\underline{2}} - 2 s \\ = 4 {π ( OD / 2 )}^{\underline{2}} - 2 {π ( d / 2 )}^{\underline{2}} \qquad ( 1 )$$

When the valve portion having the outside surface area determined by Equation (1) above generates heat due to heat losses H, the surface temperature T of the valve portion 2 is expressed as follows on the assumption that the sealing portions 3a and 3b release no heat:
T=(H/(OS×2.51×C))^{0.08}×(OD/2)^{0.2} (2)
where C is a coefficient of natural convection and heat conduction of a sphere, C=0.63.

Hence, the heat resistance R1 to natural convection in the valve portion 2 is expressed by:
R1=T/H (3)

Meanwhile, the heat resistance R2 when heat is released from the valve portion 2 to the sealing portions 3a and 3b through conduction is expressed by:

$$R2 = 1 / ( ρ \cdot s ) \\ = 1 / ( ρ \cdot {π ( d / 2 )}^{2} ) \qquad ( 4 )$$

The heat resistances R1 and R2 in the valve portion 2 can be schematically shown as FIG. 3.

From the heat resistance R1 to natural convection in the valve portion 2 and the heat resistance R2 when heat is released from the valve portion 2 to the sealing portions 3a and 3b through conduction, a combined resistance R3 of these is obtained as follows:
1/R3=(1/R1)+(1/R2)+(1/R2),
hence, we get:
R3=(R1·R2)/(2R1+R2) (5)

The surface temperature TT of the valve portion 2 when the combined resistance R3 acts on the valve portion 2 is expressed by:
TT=H·R3 (6)

Also, the inner temperature logical value ITT of the valve portion 2 (this can be assumed to be an average value of the inner temperatures that differ from site to site in the valve portion that is emitting light, and the inner temperature logical value ITT is referred to also as an average value of inner temperatures in the invention), which is obtained by taking the thickness TH of the valve portion 2 into account, on the basis, of the surface temperature TT, is expressed by:
ITT=TT+(H·TH)/(ρ·MS) (7)
where MS is a valve area at the center position in the thickness direction of the valve portion 2, and we get:
TH=(OD−ID)/2 (8)
MS=4π((ID/2)+(TH/2))² (9)

Hence, when the inner temperature logical value ITT of the valve portion 2, the inner diameter ID of valve portion, the diameter d of the sealing portions, and the length l of the sealing portions are determined in advance, the outside diameter OD of valve portion is found in the end from Equations (7), (8), and (9) above. In this case, the inner temperature logical value ITT of the valve portion 2 may be set as a predetermined target range, so that the outside diameter OD of the valve portion 2 is determined to correspond to this range. For example, in the case of a mercury lamp of high luminance used in a projector or the like, it is preferable to control the inner temperature logical value ITT of the value portion 2 to be 900° C. or above and 1000° C. or below. Hence, the outside diameter OD of the valve portion 2 is determined so that the inner temperature logical value ITT falls within this range, using computer analysis or the like.

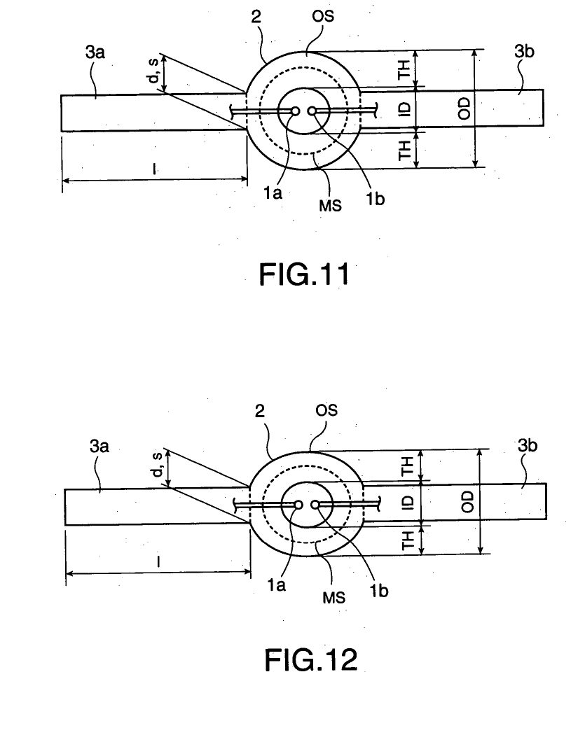

Also, for a value portion 2 as is shown in FIG. 11, having nearly a spherical outside shape with an inner face of a spheroidal shape in which the optical axis is the major axis when a direction of the both electrodes is given as the optical axis, equations of the invention to, determine OD can be also established. It should be noted, however, that, ID in this instance is a diameter of the minor axis of the ellipse.

The reason why the inner temperature logical value ITT of the valve portion 2 is set to 900° C. to 1000° C. is as follows. The light emitting lamp generally comprises quartz, and it cannot be used at a temperature at or above its heat-resistance temperature (a softening point of 1500° C.). Also, when the temperature is close to 1100° C., although quartz is not softened, the surface turns opaque due to re-crystallization and transparency is lost, which results in a loss of brightness. Conversely, at a temperature near 800° C., a halogen cycle is not circulated satisfactorily, and tungsten of the electrodes starts to adhere to the surface of the light emitting lamp and the surface turns black, which may possibly lowers the brightness. Further, the highest and lowest inner temperatures of the valve portion 2 may have a temperature difference of about 200° C. due to internal convection, and actually, it is assumed that a temperature rises as high as 1050° C. at the top of the inner face of the valve portion 2 and drops as low as 850° C. at the bottom of the inner face of the valve portion 2. By taking these into account, an average temperature of the temperatures at the top of the inner face and the bottom of the inner face of the valve portion 2 is set to a range from about 900° C. to 1000° C.

A light emitting lamp of some types is provided with reflection means on the surface or near the surface of the valve portion 2 for light emitted from the valve portion 2 to be returned again to the valve portion 2. For example, a type in which almost half the surface of the valve portion 2 is covered with a reflection film, and a type in which almost half the surface of the valve portion 2 is covered with a reflection mirror (hereinafter, referred to as the second mirror) placed to be spaced apart are known. For the light emitting lamp of such a structure, heat losses in the valve portion 2 are increased due to the presence of the reflection means. The respective sizes of the valve portion 2 in this case can be also calculated in the same manner by the method (equations) described above. It should be noted, however, that heat losses in this case are found as follows.

Table 3 below shows energy distribution in a light emitting lamp provided with the second reflection mirror in the vicinity of the valve portion 2. In the case of these lamps, losses of visible rays can be measured actually, and losses of visible rays thus measured can be assumed to be, heat losses (including radiation, convection, and conduction). The energy distribution of Table 3 below is obtained by distributing heat losses according to loss ratios of radiation and convection conduction of Table 1 above. Further, Table 4 shows heat losses due to convection and conduction, calculated to correspond to the lamp power on the basis of Table 3 below. Table 4 below corresponds to Table 2 above.

TABLE 3

| | | Energy Distribution with |
|---|---|---|
| | | Second Reflection Mirror |
| UV rays | | 10.0% |
| Visible | 380-430 nm | 5.1% |
| | 430-670 nm | 19.1% |
| | 670-780 nm | 3.6% |
| Infrared rays | | 30.0% |
| Heat Loss | Radiation | 25.1% |
| | Convection · Conduction | 7.1% |

TABLE 4

| | Heat Loss (W) Due to Convection · Conduction |
|---|---|
| Lamp Power (w) | without Second Reflection Mirror |
| 100 | 7.1 |
| 130 | 9.2 |
| 150 | 10.6 |
| 165 | 11.7 |
| 180 | 12.7 |
| 200 | 14.1 |
| 250 | 17.7 |
| 300 | 21.2 |

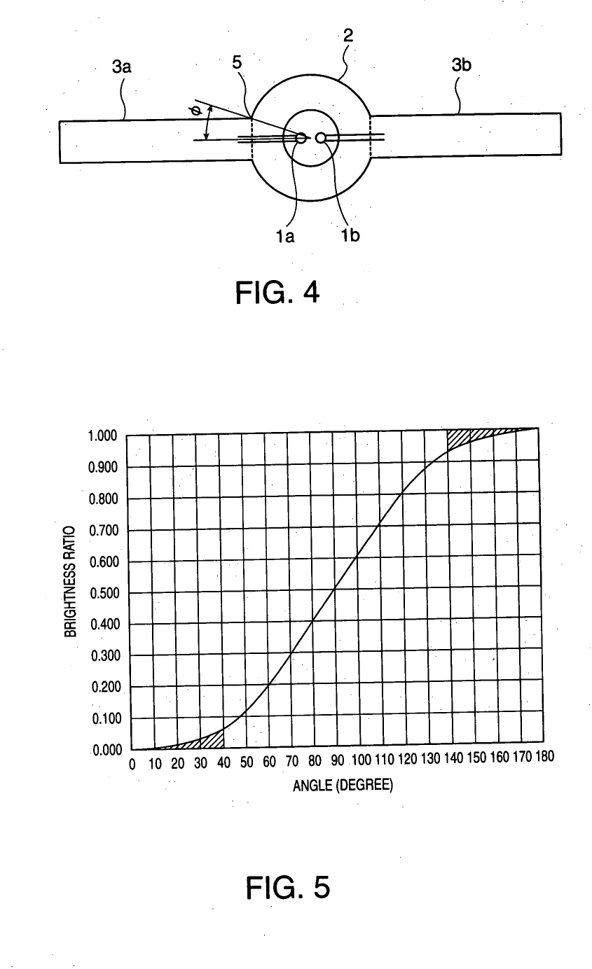

Incidentally, in the actual light emitting lamp, a ratio of the cross section area s of the sealing portions 3a and 3b to the surface area of the valve portion 2 increases as the outside diameter OD of the valve portion 2 becomes smaller, which in turn increases a ratio of light emitted from the valve portion 2 and blocked by the sealing portions 3a and 3b. Hence, as is shown in FIG. 4, it is preferable to set an angle (, produced by a virtual line linking the center between the electrodes 1a, and 1b of the valve portion 2 and an end portion 5 of the boundary of the valve portion 2 and the sealing portions 3a and 3b and a reference line linking the electrodes 1a and 1b, to be within 40 degrees. The valve portion 2 and the sealing portions 3a and 3b are made continuously from the same material; however, virtual boundaries (indicated by broken lines) are assumed for ease of explanation. The value of 40 degrees is found on the ground as follows. A light distribution characteristic by a light source having a specific reference length and homogeneous brightness is accumulated from 0 to 180 degrees to calculate ratios, which are shown as in FIG. 5 by using the ordinate for brightness ratios and the abscissa for angles. It is understood from FIG. 5 that even a total of the brightness ratios in ranges of angles from 0 to 40 degrees and angles from 140 to 180 degrees falls within 0.2. Hence, by providing the sealing portions 3a and 3b so as to come in a portion corresponding to this angle, that is, a range of ±40 degrees from the reference line, which is a line linking the centers of the electrodes, it is possible to utilize 80% or more of luminescent light generated in the electrodes 1a and 1b.

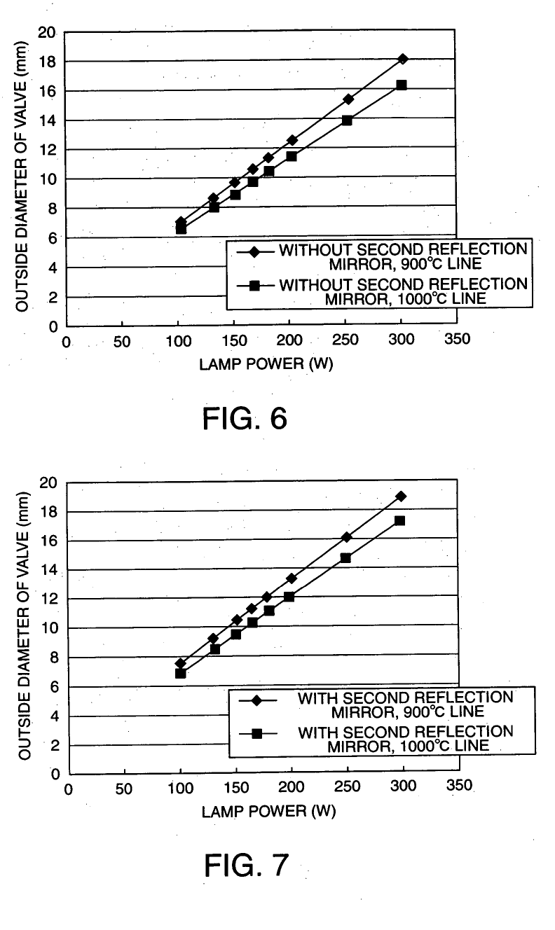

A concrete example to find the outside diameter of the valve portion 2 using Equations (7), (8), and (9) above will now be described. The sizes determined in advance are the inside diameter ID of valve portion: 4.9 mm, the diameter d of sealing portions: 5.5 mm, and the length l of sealing portions: 20 mm. The light emitting lamp is set to the lamp power set forth in Table 2 and Table 4 above for the case without the second reflection mirror and the case with the second reflection mirror, respectively, and heat loss values due to convection and conduction in each table are used. Then, the outside diameter OD of valve portion is calculated when the inner temperature logical value ITT of valve portion is controlled to be in a range from 900° C. to 1000° C. both inclusive, independently in the case without the second reflection mirror and the case with the second reflection mirror. The results are indicated by dots in FIG. 6 and FIG. 7, and these dots are linked by lines. Hence, under this condition, it is sufficient to set the outside diameter OD of valve portion to be between two lines (including the lines) of FIG. 6 that correspond to lamp power in the case without the second reflection mirror, and to be between two lines (including the lines) of FIG. 7 that correspond to: lamp power in the case with the second reflection mirror.

The first embodiment has described a case where the valve portion of the light emitting lamp has nearly a spherical outside shape; however, the invention can be applied to a case where the valve portion is of any other shape. For example, the invention can be applied to a valve portion as is shown in FIG. 12, having spheroidal outside and inside shapes. It should be appreciated, however, that for calculations to determine the outside diameter OD of valve portion in this case, the equations specific to a sphere as described above need to be adjusted or changed according to the characteristic of the elliptical shape.

Second Embodiment

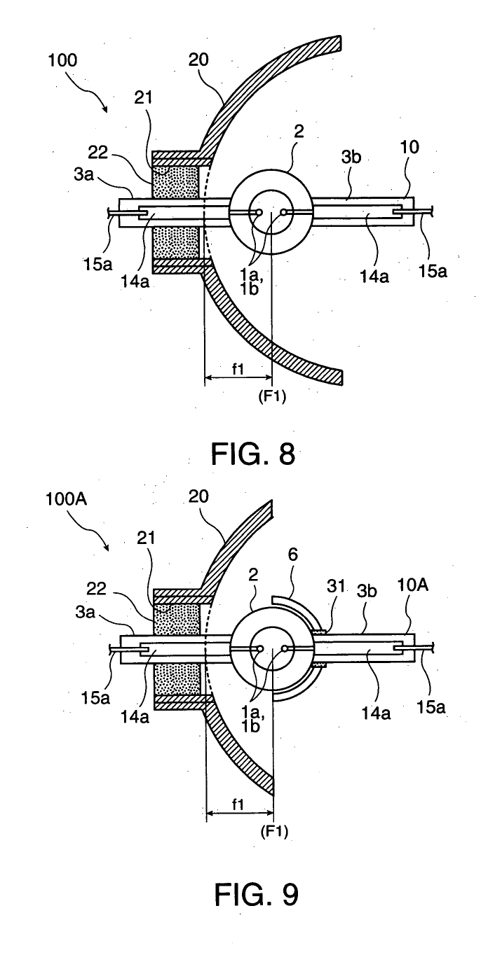

A lighting apparatus equipped with a light emitting lamp whose sizes are determined by the method as described above will now be described. FIG. 8 is a view showing the configuration of a first lighting apparatus 100 according to a second embodiment of the invention. The lighting apparatus 100 comprises a light emitting lamp 10, and a first reflection mirror 20 on which light emitted backward from the valve portion 2 in the light emitting lamp 10 is reflected forward. The first reflection mirror 20 can be, for example, of an elliptical shape. The light emitting lamp 10, with one end 3a of the sealing portion 2 being inserted into a through-hole 21 at the bottom of the first reflection mirror 20, is fixed integrally to the first reflection mirror 20 with an inorganic adhesive agent 22, such as cement. In the sealing portions 3a and 3b are respectively sealed metal foils 14a and 14b made of molybdenum that are connected to the electrodes 1a and 1b, respectively. Lead lines 15a and 15b that can be connected to the outside are provided to the metal foils 14a and 14b, respectively.

Also, FIG. 9 is a view showing the configuration of a second lighting apparatus 100A according to the second embodiment of the invention. The same reference numerals as those of FIG. 8 denote the same or equivalent components as those shown in FIG. 8. The lighting apparatus 100A includes a second reflection mirror 6 to return light, which a light emitting lamp 10A emits forward from the valve portion 2, again to the valve portion 2. The second reflection mirror 6 is placed in such a manner that the reflection surface surrounds almost half the front of the valve portion 2, and that light emitted from the center between the electrodes 1a and 1b to go incident on the second reflection mirror 6 agrees with the normal line to the reflection surface of the second reflection mirror 6. The second reflection mirror 6 is fixed to one sealing portion 3b with cement 31 or the like. Also, when the first reflection mirror 20 is of an elliptical shape, the center between the electrodes 1a and 1b is positioned at almost the same position of a first focal point F1 of the first reflection mirror 20. Because the reflection surface of the second reflection mirror 6 surrounds almost half the front of the valve portion 2, the reflection surface of the first reflection mirror 20 may be of a size large enough to cover almost half the rear of the valve portion 2. This configuration makes the first reflection mirror 20 markedly smaller than the counterpart of FIG. 8. Also, this configuration allows a large portion of the light emitting lamp 10A to protrude outward from the open edge of the reflection surface of the first reflection surface 20.

It is preferable to secure a space of 0.2 mm or larger between the valve portion 2 and the second reflection mirror 6 to promote heat release from the valve portion 2 on the side covered with the second reflection mirror 6. The backside of the second reflection mirror 6 is formed to have a reflection film or a shape to transmit light (infrared rays, UV rays, visible rays leaking from the reflection surface side) that comes incident from the reflection surface side, or to diffuse-reflect light that comes incident from the reflection surface side, in preventing the second reflection mirror 6 from absorbing light as much as possible.

The lighting apparatus 100A configured as described above operates as follows. That is, light emitted from the back of the valve portion 2 is reflected on the first reflection mirror 20 to travel forward of the lighting apparatus 10A. Also, light emitted from the front of the valve portion 2 is reflected on the second reflection mirror 6 to be returned again to the valve portion 2, and then comes out therefrom to go incident on the first reflection mirror 20. This light is also reflected on the first reflection mirror 20 and travels forward of the lighting apparatus 10A. It is thus possible to utilize almost the entire light emitted from the valve portion 2.

According to the lighting apparatus 100 and 100A of the second embodiment, because temperatures of the light emitting lamps 10 and 10A used therein are maintained at adequate values, it is possible to avoid the lamps from turning opaque or black, which can in turn prevent deterioration in quality of illumination light.

Third Embodiment

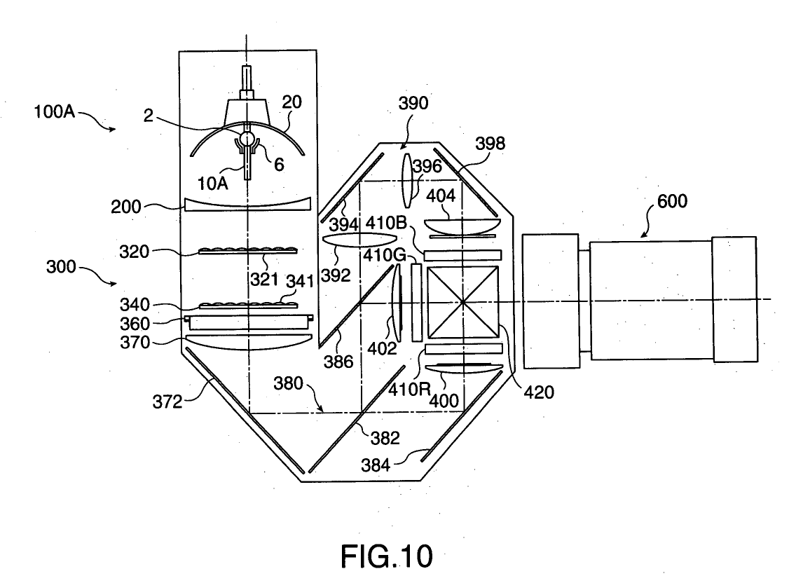

FIG. 10 is a view showing the configuration of a projector equipped with the light emitting lamp of the invention, that is, the light emitting lamp 10A herein. This optical system includes: a lighting optical system 300 provided with the lighting apparatus 101A comprising the light emitting lamp 10A, the first reflection mirror 20, and the second reflection mirror 6, and means for adjusting light emitted from the lighting apparatus 100A to predetermined light; a color light separation optical system 380 including dichroic mirrors 382 and 386, a reflection mirror 384, etc.; a relay optical system 390 including an incident side lens 392, a relay lens 396, reflection mirrors 394 and 398; fields lenses 400, 402, and 404 and liquid crystal panels 410R, 410G, and 410B serving as light modulation devices that correspond to respective colors; a crossed dichroic prism 420 serving as color light synthesizing optical system; and a projection lens 600.

Operations of the projector configured as described above will now be described. Light emitted from the back of the center of the valve portion 2 in the light emitting lamp 10A is first reflected on the first reflection mirror 20 to travel forward of the lighting apparatus 100A. Also, light emitted from the front of the center of the valve portion 2 is reflected on the second reflection mirror 6 to be returned to the first reflection mirror 20, and then is reflected on the first reflection mirror 20 to travel forward of the lighting apparatus 100A.

Light coming out from the lighting apparatus 100A goes incident on a concave lens 200, and is adjusted so that the light traveling direction will be almost parallel to the optical axis 1 of the lighting optical system 300, after which the light goes incident on respective small lenses 321 of a first lens array 320 forming an integrator lens. The first lens array 320 divides incident light into a plurality of partial light beams in the matching number with the number of the small lenses 321. Respective partial light beams coming out from the first lens array 320 go incident on a second lens array 340 that includes small lenses 341 respectively corresponding to the small lenses 321 and thereby forming an integrator lens. Light emitted from the second lens array 340 is then condensed in the vicinity of a polarization separation film (omitted from the drawing) corresponding to a polarization converting element array 360. In this instance, a blocking plate (omitted from the drawing) adjusts light to go incident on the polarization converting element array 360 to go incident on only a portion corresponding to the polarization separation film.

Light beams incident on the polarization converting element array 360 are converted to linearly polarized light of the same kind. A plurality of partial light beams whose polarization directions have been aligned in the polarization converting element array 360 then go incident on a superimposing lens 370 to be adjusted in such a manner that respective partial light beams to irradiate the liquid crystal panels 410R, 410G, and 410B will be superimposed on the corresponding panel screens.

The color light separation optical system 380 is provided with first and second dichroic mirrors 382 and 386, and is furnished with a function of separating light emitted from the lighting optical system into rays of light of three colors, including red, green, and blue.

The first dichroic mirror 382 transmits red light components of the light emitted from the superimposing lens 370, and reflects blue light components and green light components. Red light that has passed through the first dichroic mirror 382 is reflected on the reflection mirror 384 and reaches the liquid crystal panel 410R for red light through the field lens 400. The field lens 400 converts respective partial light beams emitted from the superimposing lens 370 to light beam parallel to the central axis (chief ray). The field lenses 402 and 404 provided in front of the other liquid crystal panels 410G and 410B, respectively, function in the same manner.

Further, of the blue light and the green light reflected on the first dichroic mirror 382, the green light is reflected on the second dichroic mirror 386, and reaches the liquid crystal panel 410G for green light through the field lens 402. Meanwhile, the blue light passes through the second dichroic mirror 386, and passes by the relay optical system 390, that is, the incident side lens 392, the reflection mirror 394, the relay lens 396, and the reflection mirror 398, and then reaches the liquid crystal panel 410B for blue light through the field lens 404. The relay optical system 390 is used for blue light to prevent deterioration of efficiency of light utilization caused by scattering of light or the like, because the optical path length of blue light is longer than the optical lengths of light of the other colors. In other words, it is aimed at transmitting partial light beams incident on the incident side lens 392 to the field lens 404 intact. The relay optical system 390 is configured to transmit blue light among light of three colors; however, it may be configured to transmit light of other colors, such as red light.

Three liquid crystal panels 410R, 410G, and 410B modulate incident light of their respective colors according to provided video information, and thereby form images of light of respective colors. Incidentally, polarizing plates are normally provided on the light incident side and the light emitting side of each of three liquid crystal panels 410R, 410G, and 410B.

Rays of modulation light of three colors emitted from the respective liquid crystal panels 410R, 410G, and 410B go incident on the crossed dichroic prism 420 furnished with a function of the color light synthesizing optical system that synthesizes rays of modulation light to form a color image. In the crossed dichroic prism 420, a dielectric multi-layer film to reflect red light and a dielectric multi-layer film to reflect blue light are formed on the interfaces of four rectangular prisms almost in the shape of a letter X. These dielectric multi-layer films synthesize rays of modulation light of three colors, including red, green, and blue, to form synthesized light for a color image to be projected. Synthesized light synthesized in the crossed dichroic prism 420 finally goes incident on the projection lens 600, and is then projected onto a screen to be displayed as a color image.

According to the projector described above, because the temperature of the light emitting lamp 10A used therein is maintained at an adequate value, it is possible to avoid the light emitting lamp from turning opaque or black, which can in turn suppress deterioration in quality of a display image of the projector.

The light emitting lamp of the invention can be used as a light source for various kinds of lighting apparatus and optical devices.

It should be appreciated that the invention is not limited to the embodiments above, and can be implemented in various modes without deviating from the scope of the invention. For example, modifications as follows are possible.

While the embodiment above has described only a projector using three liquid crystal panels 410R, 410G, and 410B by way of example, the invention is applicable to a projector using a single liquid crystal panel, a projector using two liquid crystal panels, or a projector using four or more liquid crystal panels.

Also, the embodiments above use a transmission liquid crystal panel in which the light incident surface and the light emitting surface are different; however, a reflection liquid crystal panel may be used, in which the light incident surface and the light emitting surface are the same.

While the embodiment above adopt the liquid crystal panels 410R, 410G, and 410B as light modulation devices, the invention is not limited to this configuration, and the invention may be adopted as a light source apparatus to illuminate a device that performs light modulation with the use of micro mirrors. In this case, the polarizing plates on the light beam incident side and the light beam emitting side can be omitted.

The embodiment above adopt the light source apparatus of the invention for a projector equipped with the light modulation device; however, the invention is not limited to this configuration, and the light source apparatus of the invention can be applied to other optical devices.

While the embodiment above have described only a front type projector to perform projection in a direction in which the screen is observed by way of example, the invention can be applied to a rear type projector to perform projection in a direction opposite to the direction in which the screen is observed.

1. A light emitting lamp, comprising:
a pair of electrodes;
a bulb portion enclosing the pair of electrodes, and
sealing portions placed integrally with the bulb portion on sides of the bulb portion and provided with conductors connected to the electrodes,
three values among values of four sizes, including an inside diameter of the bulb portion, an outside diameter of the bulb portion, a diameter of the sealing portions, and a length of the sealing portions, and a value of a quantity of power-consumption-dependent heat losses due to convection and conduction of the bulb portion being determined in advance, and a value of a remaining one size among respective sizes of the bulb portion being determined on the basis of the determined values, for an average value of inner temperatures of the bulb portion to be a target value determined in advance.

2. The light emitting lamp according to claim 1:
the quantity of heat losses due to convection and conduction of the bulb portion, the inside diameter of the bulb portion, the diameter of the sealing portions, and the length of the sealing portions being determined in advance; and
the outside diameter of the bulb portion being determined on the basis of the quantity of heat losses, the inside diameter of the bulb portion, the diameter of the sealing portions, and the length of the sealing portions, for an average value of the inner temperatures of the bulb portion to fall within a target range.

3. The light emitting lamp according to claim 1:
TT is a surface temperature of the bulb portion, H is the quantity of heat losses due to convection and conduction of the bulb portion, TH is a thickness of the bulb portion, ρ is a coefficient of heat conduction of a material forming the bulb and the sealing portions, MS is a bulb area at a center position in a thickness direction of the bulb portion, and ITT is the average value of the inner temperatures, then ITT is given as:
ITT=TT+(H·TH)/(ρ·MS)

4. The light emitting lamp according to claim 3:
T is a surface temperature of the bulb portion on the assumption that no heat is released from the sealing portions of the bulb portion, R3 is a combined resistance of a heat resistance R1 from the bulb portion to natural convection and a heat resistance R2 from the bulb portion to the sealing portions through conduction, l is the length of the sealing portions, and d is a diameter of the sealing portions, then:
TT=H·R3,
R3=(R1·R2)/(2R1+R2),
R1=T/H,
R2=1/(ρ·π·(d/2)²)

5. The light emitting lamp according to claim 1:
the average value of the inner temperatures being set to 900° C. or above and 1000° C. or below.

6. The light emitting lamp according to claim 1:
an angle, produced by a virtual line linking a center between the electrodes of the bulb portion and one end of a boundary of the bulb portion and the sealing portions and a reference line linking between the electrodes, being set to be within 40 degrees.

7. The light emitting lamp according to claim 1, further including:
reflection device to return light emitted from the bulb portion again to the bulb portion.

8. A lighting apparatus, in which:
a lamp fixed to a bottom of a concave reflection mirror, the lighting apparatus including
the light emitting lamp according to claim 1 being provided as the lamp.

9. The lighting apparatus according to claim 8:
for the light emitting lamp, the quantity of heat losses due to convection and conduction of the bulb portion, the inside diameter of the bulb portion, the diameter of the sealing portions, and the length of the sealing portions being determined in advance; and
the outside diameter of the bulb portion being determined on the basis of the quantity of heat losses, the inside diameter of the bulb portion, the diameter of the sealing portions, and the length of the sealing portions, for the average value of the inner temperatures of the bulb portion to fall within a target range.

10. The lighting apparatus according to claim 8:
for the light emitting lamp, TT is a surface temperature of the bulb portion, H is the quantity of heat losses due to convection and conduction of the bulb portion, H is a thickness of the bulb portion, ρ is a coefficient of heat conduction of a material forming the bulb and the sealing portions, MS is a bulb area at a center position in a thickness direction of the bulb portion, and ITT is the average value of the inner temperatures, then ITT is given as:
ITT=TT+(H·TH)/(ρ·MS)

11. The lighting apparatus according to claim 10:
for the light emitting lamp, T is a surface temperature of the bulb portion on the assumption that no heat is released from the sealing portions of the bulb portion, R3 is a combined resistance of a heat resistance R1 from the bulb portion to natural convection and a heat resistance R2 from the bulb portion to the sealing portions through conduction, l is the length of the sealing portions, and d is the diameter of said the sealing portions, then:
TT=H·R3,
R3=(R1·R2)/(2R1+R2),
R1=T/H,
R2=1/(ρ·π·(d/2)²)

12. The lighting apparatus according to claim 8:
the average value of the inner temperatures of the light emitting lamp being set to 900° C. or above and 1000° C. or below.

13. The lighting apparatus according to claim 8, wherein:
for the light emitting lamp, an angle, produced by a virtual line linking a center between the electrodes of the bulb portion and one end of a boundary of the bulb portion and the sealing portions and a reference line linking between the electrodes, being set to be within 40 degrees.

14. The lighting apparatus according to claim 8:
the light emitting lamp further including a reflection device to return light emitted from the bulb portion again to the bulb portion.

15. A projector to form an image by allowing illumination light from a lighting apparatus to go incident on a light modulation device for the image to be projected, comprising:
the lighting apparatus according to claim 8 being provided as the lighting apparatus.

16. The projector according to claim 15:
for the light emitting lamp in the lighting apparatus, the quantity of heat losses due to convection and conduction of the bulb portion, the inside diameter of the bulb portion, the diameter of the sealing portions, and the length of the sealing portions being determined in advance; and
the outside diameter of the bulb portion being determined on the basis of the quantity of heat losses, the inside diameter of the bulb portion, the diameter of the sealing portions, and the length of the sealing portions, for the average value of the inner temperatures of the bulb portion to fall within a target range.

17. The projector according to claim 15:
for the light emitting lamp in the lighting apparatus, TT is a surface temperature of the bulb portion, H is the quantity of heat losses due a to convection and conduction of the bulb portion, TH is a thickness of the bulb portion, ρ is a coefficient of heat conduction of a material forming the bulb and the sealing portions, MS is a bulb area at a center position in a thickness direction of the bulb portion, and ITT is the average value of the inner temperatures, then ITT is given as:
ITT=TT+(H·TH)/(ρ·MS)

18. The projector according to claim 17:
for the light emitting lamp in the lighting apparatus, let T be a surface temperature of the bulb portion on the assumption that no heat is released from the sealing portions of the bulb portion, R3 is a combined resistance of a heat resistance R1 from the bulb portion to natural convection and a heat resistance R2 from the bulb portion to the sealing portions through conduction, l is the length of the sealing portions, and d is the diameter of the sealing portions, then we get:
TT=H·R3,
R3=(R1·R2)/(2R1+R2),
R1=T/H,
R2=1/(ρ·π·(d/2)²)

19. The projector according to claim 15:
the average value of the inner temperatures of the light emitting lamp in the lighting apparatus being set to 900° C. or above and 1000° C. or below.

20. The projector according to claim 15:
for the light emitting lamp in the lighting apparatus, an angle, produced by a virtual line linking a center between the electrodes of the bulb portion and one end of a boundary of the bulb portion and the sealing portions and a reference line linking between the electrodes, being set to be within 40 degrees.

21. The projector according to claim 15:
the light emitting lamp in the lighting apparatus further including reflection device to return light emitted from the bulb portion again to the bulb portion.
